(19) United States
(12) Patent Application Publication
(10) Pub. No.: US 2026/0320531 A1
(43) Pub. Date: Oct. 15, 2026

(54) APPARATUS AND METHOD FOR OPERATING SMART FARM BASED ON ARTIFICIAL INTELLIGENCE

(71) Applicant: KOREA INSTITUTE OF SCIENCE AND TECHNOLOGY, Seoul (KR)

(72) Inventors: Moon SON, Seoul (KR); Sung Ho CHAE, Seoul (KR); Si-Kyung CHO, Seoul (KR); Uijeong HAN, Goyang-si (KR)

(73) Assignee: KOREA INSTITUTE OF SCIENCE AND TECHNOLOGY, Seoul (KR)

(21) Appl. No.: 19/463,595

(22) Filed: Jan. 29, 2026

(30) Foreign Application Priority Data
Mar. 28, 2025 (KR) 10-2025-0040015

(51) Int. Cl. G06Q 10/0637; G06Q 50/02

(52) U.S. Cl. CPC G06Q 10/06375; G06Q 50/02

(57) ABSTRACT

The present disclosure relates to an apparatus and method for operating a smart farm that use the artificial intelligence to predict operating conditions for maximizing crop production. The apparatus includes: a data collection unit collecting crop cultivation data during the operation of the smart farm; a training unit training a first prediction model about a correlation between crop production and an operating condition based on the crop cultivation data collected over a predetermined period; a prediction unit predicting the crop production via the first prediction model and to derive the operating condition for obtaining maximum profit based on the predicted crop production; and a predicted result providing unit requesting a prediction from the prediction unit when a prediction request is input from a user, and generating a response via a language model based on predicted results of the prediction unit and provides the response to the user.

### CROSS REFERENCE TO RELATED APPLICATION

The present application claims priority to Korean Patent Application No. 10-2025-0040015, filed Mar. 28, 2025, the entire contents of which are hereby incorporated by this reference.

### BACKGROUND OF THE INVENTION

### Field of the Invention

The present disclosure relates to an apparatus and method for operating a smart farm based on artificial intelligence, and more particularly, to an apparatus and method for operating a smart farm based on artificial intelligence that use artificial intelligence to predict smart farm operating conditions for maximizing crop production, to maximize profits by linking the crop production with crop prices, and to provide information on predicted results in a manner easily understandable to farmers.

### Statement of Government-sponsored Research and Development

The present disclosure resulted from the support of the National Research Foundation of Korea funded by the Ministry of Science and ICT (Project Identification No.: 2710009821, Project No.: 2021R1C1C2005643, Research Program Title: Individual Basic Research (Ministry of Science and ICT), Research Project Title: Optimization of Electrochemical Water Treatment–Renewable Energy Production Process Using Deep Learning, Research Institution:

Korea Institute of Science and Technology, Research Period: Mar. 1, 2024 to Feb. 28, 2025).

### DESCRIPTION OF THE RELATED ART

A smart farm is an intelligent agricultural system that integrates information and communications technology (ICT) into the production, processing, and distribution stages of agricultural products, forest products, livestock products, and fishery products.

The smart farm uses the ICT technology to analyze, predict, and manage environmental information, crop growth data, etc., thereby enabling improved crop productivity and quality even with less labor, energy, nutrients, etc., than the traditional farming.

Currently, the smart farm technology has used Internet of Things (IoT) and big data technologies to increase agricultural efficiency. For example, by measuring environmental data, such as temperature, humidity, illuminance (light intensity), and soil moisture in real time, automated systems may manage crops.

However, even if such technologies are applied, the crop cultivation methods themselves often still follow agricultural practices of farmers.

In other words, a greenhouse opening and closing apparatus, a heating and cooling system, an irrigation system, etc., operate based on data, but the cultivation methods themselves are often determined by a farmer's experience or a company's technical know-how.

Therefore, the smart farm is not fully automated, and there are limitations to maximizing crop production.

In addition, there are also limitations to maximizing profits by adjusting crop production in accordance with sales price trends of crops that follow a predetermined cycle.

### SUMMARY OF THE INVENTION

The present disclosure is directed to providing an apparatus and method for operating a smart farm based on artificial intelligence that use the artificial intelligence to predict smart farm operating conditions for maximizing crop production, securing crop production that maximizes profits by linking the crop production with crop prices, and providing information on predicted results in a manner easily understandable to farmers.

To achieve the above-described objects, according to an aspect of the present disclosure, an apparatus for operating a smart farm based on artificial intelligence may include: a data collection unit configured to collect crop cultivation data during the operation of the smart farm; a training unit configured to train a first prediction model about a correlation between crop production and a smart farm operating condition based on the crop cultivation data collected by the data collection unit over a predetermined period; a prediction unit configured to predict the crop production via the first prediction model and to derive the smart farm operating condition for obtaining maximum profit based on the predicted crop production; and a predicted result providing unit configured to request a prediction from the prediction unit when a prediction request is input from a user, and to generate a response via a language model based on predicted results of the prediction unit and provides the response to the user.

Also, the apparatus for operating a smart farm based on artificial intelligence according to the present disclosure may further include a data storage unit configured to store the data collected by the data collection unit.

Also, the apparatus for operating a smart farm based on artificial intelligence according to the present disclosure may further include a data preprocessing unit configured to adjust a time interval of the data collected by the data collection unit to regular time intervals, to predict and supplements missing data, and to normalize values of the collected data to a fixed range.

Also, in the apparatus for operating a smart farm based on artificial intelligence according to the present disclosure, the prediction unit may predict the crop production via the first prediction model, determine the crop production capable of maximizing profit by linking with historical crop price information, and derive the smart farm operating condition corresponding to the crop production.

Also, in the apparatus for operating a smart farm based on artificial intelligence according to the present disclosure, the prediction unit may derive the smart farm operating condition for maximizing the crop production via the first prediction model.

Also, in the apparatus for operating a smart farm based on artificial intelligence according to the present disclosure, the prediction unit may input forecasted weather data to the first prediction model to predict the crop production, determine a crop production direction based on the predicted crop production, and derive the smart farm operating condition corresponding to the determined crop production direction.

Also, in the apparatus for operating a smart farm based on artificial intelligence according to the present disclosure, the first prediction model may be implemented as a 1-1st prediction model and a 1-2nd prediction model, and the training unit may use, as training data, crop cultivation data collected by the data collection unit over an entire period to train the 1-1st prediction model, and use, as the training data, crop cultivation data of a recent predetermined period among the crop cultivation data collected by the data collection unit to train the 1-2nd prediction model.

Also, in the apparatus for operating a smart farm based on artificial intelligence according to the present disclosure, the prediction unit may predict entire period-based crop production via the 1-1st prediction model and derive the smart farm operating condition for obtaining the predicted crop production, or predict crop production based on a recent period via the 1-2nd prediction model and derive the smart farm operating condition for obtaining the predicted crop production.

Also, in the apparatus for operating a smart farm based on artificial intelligence according to the present disclosure, the predicted result providing unit may be linked with the language model to generate and provide, in natural language, descriptions of the crop production predicted by the prediction unit and the smart farm operating condition derived to obtain the predicted crop production.

Also, in the apparatus for operating a smart farm based on artificial intelligence according to the present disclosure, the predicted result providing unit may be linked with a retrieval-augmented generation system to generate and provide, in natural language, descriptions of the crop production predicted by the prediction unit and the smart farm operating condition derived to obtain the predicted crop production, and may retrieve relevant information from outside and then use the retrieved relevant information to generate descriptions to be provided to the user.

Also, in the apparatus for operating a smart farm based on artificial intelligence according to the present disclosure, the predicted result providing unit may be linked with the retrieval-augmented generation system to generate and provide, in natural language, the descriptions of the crop production predicted by the prediction unit and the smart farm operating conditions derived to obtain the predicted crop production and generate and provide an answer to a user's question.

Also, in the apparatus for operating a smart farm based on artificial intelligence according to the present disclosure, the crop cultivation data may include at least one of environmental data, crop growth data, soil and nutrient data, irrigation and resource usage data, smart farm operation data, and crop production data.

Also, in the apparatus for operating a smart farm based on artificial intelligence according to the present disclosure, the data collection unit may collect crop price data for a set period and weather data for the corresponding period, the training unit may train a second prediction model about a correlation between crop price and weather based on the price and weather data collected by the data collection unit, and the prediction unit may input forecasted weather data to the second prediction model to predict a future crop price, and determine a crop production direction based on the crop production predicted by the first prediction model and the future crop price predicted by the second prediction model, and then derive the smart farm operating condition corresponding to the determined crop production direction.

Also, to achieve the above-described objects, a method for operating a smart farm based on artificial intelligence may include: collecting crop cultivation data during the operation of the smart farm; training a first prediction model about a correlation between crop production and a smart farm operating condition based on the crop cultivation data collected in the collecting of the crop cultivation data over a predetermined period; predicting the crop production via the first prediction model and deriving the smart farm operating condition for obtaining the predicted crop production; and generating a response via a language model based on predicted results in the predicting of the crop production and providing the generated response to a user.

Also, the method for operating a smart farm based on artificial intelligence according to the present disclosure may further include: preprocessing data by adjusting a time interval of data collected in the collecting of the crop cultivation data to regular time intervals, predicting and supplementing missing data, and normalizing values of the collected data to a fixed range.

Also, for the method for operating a smart farm based on artificial intelligence according to the present disclosure, the predicting of the crop production may include: predicting the crop production via the first prediction model; and determining the crop production that maximizes profit by linking with historical crop price information; and deriving the smart farm operating condition corresponding to the crop production.

Also, for the method for operating a smart farm based on artificial intelligence according to the present disclosure, the predicting of the crop production may include: deriving the smart farm operating condition for maximizing the crop production via the first prediction model.

Also, for the method for operating a smart farm based on artificial intelligence according to the present disclosure, the predicting of the crop production may include: inputting forecasted weather data to the first prediction model to predict the crop production; determining a crop production direction based on the predicted crop production; and deriving the smart farm operating condition corresponding to the determined crop production direction.

Also, for the method for operating a smart farm based on artificial intelligence according to the present disclosure, the first prediction model may be implemented as a 1-1st prediction model and a 1-2nd prediction model, and the training of the first prediction model may include: training the 1-1st prediction model by using crop cultivation data collected in the collecting of the crop cultivation data over an entire period as training data; and training the 1-2nd prediction model by using crop cultivation data of a recent predetermined period among the crop cultivation data collected in the collecting of the crop cultivation data as the training data.

Also, for the method for operating a smart farm based on artificial intelligence according to the present disclosure, the predicting of the crop production may include: predicting entire period-based crop production via the 1-1st prediction model, and deriving the smart farm operating condition for obtaining the predicted crop production; or predicting crop production based on a recent period via the 1-2nd prediction model, and deriving the smart farm operating condition for obtaining the predicted crop production.

Also, for a method for operating a smart farm based on artificial intelligence according to the present disclosure, the providing of the predicted results may include: generating and providing, in natural language, descriptions of the crop production predicted in the predicting of the crop production and the smart farm operating condition derived to obtain the predicted crop production, by linking with the language model.

Also, for the method for operating a smart farm based on artificial intelligence according to the present disclosure, the providing of the predicted results may include: generating and providing, in natural language, descriptions of the crop production predicted in the predicting of the crop production and the smart farm operating condition derived to obtain the predicted crop production, by linking with a retrieval-augmented generation system; and generating descriptions to be provided to the user by retrieving relevant information from outside and then uses the retrieved relevant information.

Also, for the method for operating a smart farm based on artificial intelligence according to the present disclosure, the providing of the predicted results may include: generating and providing, in natural language, the descriptions of the crop production predicted in the predicting of the crop production and the smart farm operating conditions derived to obtain the predicted crop production, by linking with the retrieval-augmented generation system; and generating and providing an answer to a user's question.

Also, for the method for operating a smart farm based on artificial intelligence according to the present disclosure, in the collecting of the crop cultivation data may include: collecting crop price data for a set period and weather data for the corresponding period, the training of the first prediction model may include: training a second prediction model about a correlation between crop price and weather based on the price and weather data collected in the collecting of the crop cultivation data, and the predicting of the crop production may include: inputting forecasted weather data to the second prediction model to predict a future crop price; and determining, by the second prediction model, a crop production direction based on the crop production predicted by the first prediction model and the future crop price predicted, and then deriving the smart farm operating condition corresponding to the determined crop production direction.

The specific details of other embodiments are included in the “Detailed Description of the Invention” and the accompanying “drawings.”

Advantages and/or features of the present disclosure and methods to achieve them will be elucidated from various embodiments described below in detail with reference to the accompanying drawings.

However, the present disclosure is not limited only to the configurations of the respective embodiments disclosed below, but can be implemented in various other forms. However, each embodiment disclosed in this specification is provided to complete the disclosure of the present disclosure and to fully inform a person of ordinary skill in the art to which the present disclosure pertains of the scope of the present disclosure. Therefore, it should be noted that the present disclosure is defined by the scope of the appended claims.

According to the present disclosure, it is possible to predict the crop production and derive the smart farm operating conditions for maximizing the crop production.

In addition, it is possible to determine the optimal crop production capable of maximizing profit by linking the crop production with the crop prices and derive the smart farm operating conditions corresponding to the determined optimal crop production.

Furthermore, by providing the derived smart farm operating conditions to a user using a natural language, it is possible to intuitively describe the derived smart farm operating conditions to the user.

Also, the user may ask questions about the smart farm operating conditions in the chat format and receive the answers to the questions.

### BRIEF DESCRIPTION OF THE DRAWINGS

FIG. 1 is a schematic diagram illustrating a configuration of an apparatus for operating a smart farm based on artificial intelligence (AI) according to an embodiment of the present disclosure.

FIG. 2 is an exemplary diagram of a predicted result via a prediction model applied to the present disclosure.

FIG. 3 is a flowchart for describing a method for operating a smart farm based on AI according to an embodiment of the present disclosure.

### DETAILED DESCRIPTION OF THE INVENTION

Before describing the present disclosure in detail, it should be noted that the terms and words used in this specification should not be interpreted as being unconditionally limited to their conventional or dictionary meanings. The inventor of the present disclosure may appropriately define and use various terms and concepts to best describe his or her invention. Furthermore, it should be noted that these terms and words are interpreted with meanings and concepts consistent with the technical teachings of the present disclosure.

In other words, the terms used in this specification are used solely to describe preferred embodiments of the present disclosure and are not intended to specifically limit the content of the present disclosure. It should be noted that these terms have been defined in consideration of various possibilities of the present disclosure.

Furthermore, in this specification, it should be noted that expressions in the singular form may include the plural form unless clearly indicated otherwise in the context, and similarly, expressions in the plural form may include the singular meaning.

Throughout this specification, when a component is described as "including" another component, it may imply that, unless specifically stated otherwise, the term does not exclude any other components, but may further include any other components as well.

Furthermore, when a component is described as “being existing inside” or “being connected to and installed in” another component, it should be noted that the component may be installed in direct connection or contact with another component, may be installed at a predetermined distance from another component. When the component is installed at a predetermined distance from another component, it should be noted that a third component or means may be present to secure or connect the corresponding component to another component, and the description of this third component or means may be omitted.

Conversely, when a component is described as being "directly connected to" or "directly access" another component, it should be understood that no third component or means exists.

Similarly, other expressions describing a relationship between respective components, that is, “between”, “directly between”, “neighboring to”, “directly neighboring to” and the like, should be similarly interpreted.

In addition, in this specification, the terms such as "one surface," "the other surface," "one side," "the other side," "first," "second," and the like, if used, are used to clearly distinguish one component from other components. It should be noted that such terms do not limit the meaning of the corresponding component.

Furthermore, in this specification, it should be noted that position-related terms, such as "upper," "lower," "left," and "right," if used, indicate the relative position of the corresponding components in the corresponding drawing. Unless an absolute position is specified for these positions, the position-related terms should not be construed as referring to the absolute position.

Furthermore, in this specification of the present disclosure, the terms such as "~unit," "~or/er," "module," and "device," if used, mean a unit capable of processing one or more functions or operations. It should be noted that the unit may be implemented using hardware, software, or a combination of hardware and software.

Furthermore, in this specification, when specifying the drawing reference numbers for each component in each drawing, the same reference numerals are used for identical components, even if those components are shown in different drawings. That is, throughout this specification, identical reference numerals refer to identical components.

In the drawings attached to this specification, the sizes, positions, and coupling relationships, etc., of each component configuring the present disclosure may be exaggerated, reduced, or omitted as necessary to clearly convey the teachings of the present disclosure or for the convenience of description. Therefore, the proportions and scale may not be exact.

Furthermore, in the following description of the present disclosure, detailed descriptions of components that may unnecessarily obscure the gist of the present disclosure, such as known technologies including prior art, may be omitted.

Hereinafter, an apparatus and method for operating a smart farm based on artificial intelligence (AI) according to a preferred embodiment of the present disclosure will be described below in detail with reference to the accompanying drawings.

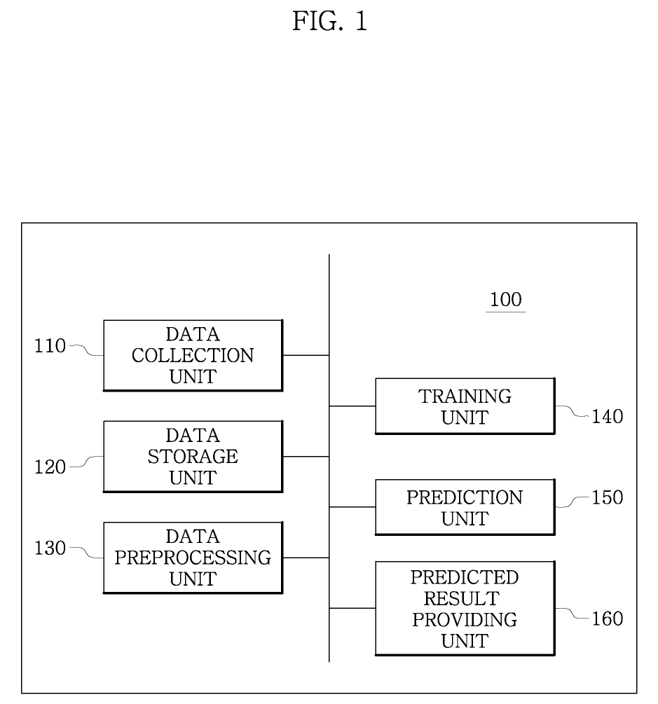

FIG. 1 is a schematic diagram illustrating a configuration of an apparatus for operating a smart farm based on AI according to an embodiment of the present disclosure.

As illustrated in FIG. 1, the apparatus 100 for operating a smart farm based on an artificial intelligence according to the present disclosure may include a data collection unit 110, a data storage unit 120, a data preprocessing unit 130, a training unit 140, a prediction unit 150, and a predicted result providing unit 160.

In this configuration, the data collection unit 110 may collect crop cultivation data during the operation of the smart farm.

The crop cultivation data collected by the data collection unit 110 may include at least one of environmental data, soil and nutrient data, crop growth data, irrigation and resource usage data, smart farm operation data, and crop production data.

Here, the environmental data refers to data on a climate environment inside and outside the smart farm, and may include sunrise time, sunset time, (external weather) minimum temperature, (external weather) maximum temperature, (external weather) average temperature, accumulated light intensity, average daily solar radiation, (greenhouse) minimum temperature, (greenhouse) maximum temperature, (greenhouse) average temperature, minimum humidity deficit (HD), maximum HD, average HD, minimum relative humidity (RH), maximum RH, average RH, ratio temperature to radiation (RTR) with respect to light intensity, barometric pressure, wind speed, wind direction, etc.

The soil and nutrient data refers to data on soil condition and nutrient concentration, and may include soil moisture, soil temperature, soil pH (acidity), electrical conductivity (EC), nutrient concentration (N-P-K), etc.

The crop growth data refers to data representing a growth status of crops and may include crop height, leaf area, chlorophyll concentration, crop growth rate, fruit size and weight, flowering and fruiting status, and pest and disease occurrence status, etc.

The irrigation and resource usage data may include irrigation amount, nutrient supply amount, irrigation EC, irrigation pH, drainage amount, drainage EC, drainage pH, absorption amount, absorption rate, nutrient supply recovery, fertilizer usage amount, pesticide usage amount, power consumption, etc.

The smart farm operation data may include smart farm device status, automated system control data, alarm, anomaly detection data, etc.

The crop production data may include crop yield, quality data, shipment date, market price, sales data, etc.

In addition, the data collection unit 110 may collect crop price data for a set period and weather data for the corresponding period.

Here, the set period may be the same as a cultivation data collection period.

The crop cultivation data, the crop price data, the weather data, etc., collected by the data collection unit 110 are time-series data collected continuously over time.

The data storage unit 120 may store the data collected by the data collection unit 110, i.e., the crop cultivation data, the crop price data, the weather data, etc., collected during the operation of the smart farm.

The data preprocessing unit 130 may adjust time intervals of the data collected by the data collection unit 110, i.e., the crop cultivation data, the crop price data, and the weather data collected during the operation of the smart farm, to regular time intervals, predict and supplement missing data, and normalize values of the collected data to a fixed range.

Specifically, raw data collected by the data collection unit 110 may have issues such as sensor errors, missing values, and unit differences. Therefore, the data preprocessing unit 130 may perform data sampling, data interpolation, data scaling, absolute value difference correction between data, etc.

The data sampling adjusts a time interval of data collected by sensors. Since each sensor may have a different measurement cycle, data is aligned at regular time intervals. In this case, when too much data is received, the sampling interval is increased to reduce computational load (downsampling), and when data is insufficient, interpolation techniques are applied to supplement samples (upsampling).

The data interpolation refers to predicting and filling in missing data. The interpolation method includes linear interpolation, spline interpolation, previous value retention, next value retention, etc.

The data interpolation may fill in missing data using different interpolation methods depending on a data type. For example, for the resource usage data, the missing data may be filled in with an average value of all measured data, and for the environmental data, the missing data may be filled in with an average value of the just previous five data.

The data scaling refers to converting (normalizing) data into a fixed range since the measurement units and ranges vary for each sensor. The data scaling method may include standardization, normalization, min-max scaling, etc.

Since the collected crop cultivation data is composed of values with different units, such as temperature, humidity, and soil pH, the absolute value difference correction between data is performed through correction processes such as normalization, logarithmic transformation, and unit conversion to align the relative differences among the data.

Such data preprocessing allows various machine learning algorithms to achieve better results.

Meanwhile, the training unit 140 may train the first prediction model about the correlation between the crop production and the smart farm operating conditions based on the crop cultivation data collected by the data collection unit 110 over a predetermined period.

The first prediction model described above may be implemented as a 1-1st prediction model and a 1-2nd prediction model, and the training unit 140 may use, as the training data, the crop cultivation data collected by the data collection unit 110 over the entire period to train a 1-1st prediction model, and use, as the training data, crop cultivation data of a recent predetermined period (e.g., the past year, the past two years, etc.) among the crop cultivation data collected by the data collection unit 110 to train a 1-2nd prediction model.

Here, the reason for training the prediction model using the crop cultivation data of the recent predetermined period is to reflect changes in environmental conditions due to rapid climate change.

In addition, the training unit 140 may train the second prediction model about the correlation between crop prices and weather based on the crop price data and weather data collected by the data collection unit 110.

The second prediction model described above may be implemented as a 2-1st prediction model and a 2-2nd prediction model, and the training unit 140 may use, as the training data, the crop price data and weather data collected by the data collection unit 110 over the entire period to train the 2-1st prediction model, and use, as the training data, the crop price data and weather data of a recent predetermined period (e.g., the past year, the past two years, etc.) among the crop price data and weather data collected by the data collection unit 110 to train a 2-2nd prediction model.

For convenience of description, in the embodiment of the present disclosure, the prediction model that is trained about (or that learns) the correlation between the crop production and the smart farm operating conditions and the prediction model that is trained about (or that learns) the correlation between the crop prices and the weather are implemented as separate, independent models. However, the present disclosure is not limited thereto, and the two types of training (or learning) described above may be implemented in a single prediction model.

In addition, the prediction model that performs learning using, as training data, data collected by the data collection unit 110 over the entire period, and the prediction model that performs learning using, as the training data, among data collected by the data collection unit 110, data collected over the recent predetermined period (e.g., the past year, the past two years, etc.) are implemented as separate, independent models. However, the present disclosure is not limited thereto, and the two types of training (or learning) may be implemented in a single prediction model.

In addition, the prediction model applied to the present disclosure may be implemented in various ways based on artificial intelligence (AI) technology. That is, the prediction model may be implemented as any of a deep learning model, a machine learning model, a hybrid model, or a reinforcement learning model, but is not limited thereto.

Meanwhile, the prediction unit 150 may predict crop production via the first prediction model when current environmental conditions are given. In addition, the prediction unit 150 may derive the smart farm operating conditions for obtaining the predicted crop production. In this case, the prediction unit 150 may derive the smart farm operating conditions for obtaining maximum profit based on the predicted crop production.

Here, the current environmental conditions may include weather conditions, location information, and environmental data (sunrise time, sunset time, (external weather) minimum temperature, (external weather) maximum temperature, (external weather) average temperature, accumulated light intensity, daily average solar irradiance, (greenhouse) minimum temperature, (greenhouse) maximum temperature, (greenhouse) average temperature, minimum HD, maximum HD, average HD, minimum RH, maximum RH, average RH, RTR with respect to light intensity, barometric pressure, wind speed, wind direction, etc.) of the crop cultivation area collected over a recent predetermined period, some or all of which may be used.

Here, the smart farm operating conditions may include, but are not limited to, drainage type, drainage combination, drainage amount, internal air temperature, internal humidity, temperature/humidity in a specific area, carbon dioxide level, and relative humidity.

The prediction unit 150 may predict crop production on a time-series manner, for example, on a monthly or weekly basis, through time-series analysis.

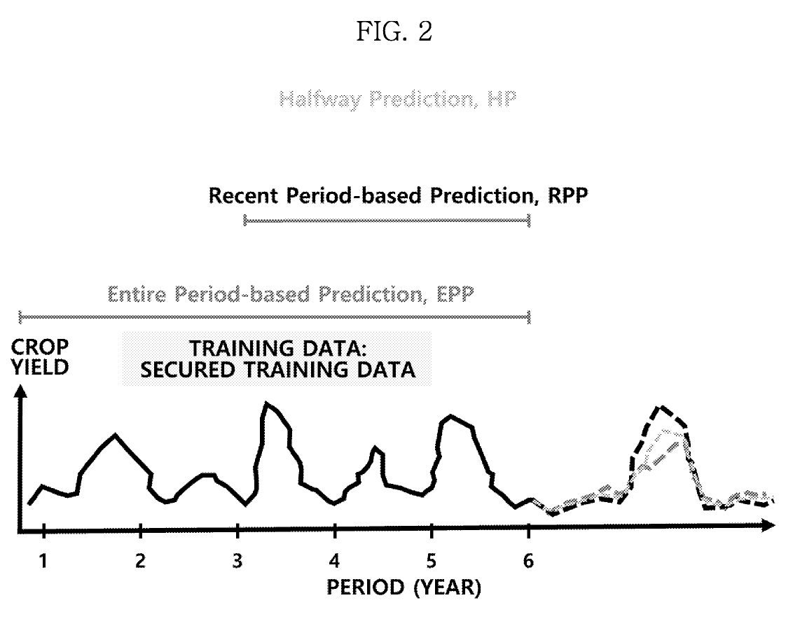

As illustrated in FIG. 2, the prediction unit 150 may predict the crop production (hereinafter, referred to as "entire period-based prediction") using the crop cultivation data collected by the data collection unit 110 over the entire period. That is, the crop production may be predicted by the 1-1st prediction model.

In addition, the prediction unit 150 may predict the crop production (hereinafter, referred to as "recent period-based prediction") using the crop cultivation data collected over a recent predetermined period (e.g., the past year, the past two years, etc.), among the crop cultivation data collected by the data collection unit 110. That is, the crop production may be predicted by the 1-2nd prediction model.

In addition, the prediction unit 150 may provide, as the predicted results, a median between the predicted results of the entire period-based prediction and the predicted results of the recent period-based prediction (hereinafter referred to as "halfway prediction").

In this way, the prediction unit 150 may perform the entire period-based prediction, the recent period-based prediction, and the halfway prediction, respectively, and predict the crop production with different values for each prediction, so the derived smart farm operating condition scenarios may also vary.

The accuracy of the crop production predicted by the prediction unit 150 through the entire period-based prediction, the recent period-based prediction, and the halfway prediction may be presented together with unpredeterminedty.

Meanwhile, the prediction unit 150 may predict crop production via the first prediction model when current environmental conditions are given, determine an optimal crop production capable of maximizing profit by linking with historical crop price information, and derive smart farm operating conditions corresponding to the optimal crop production. The historical crop price information may be received as input separately or retrieved from an external database using the information retrieval function.

In addition, the prediction unit 150 may predict the crop production via the first prediction model when the current environmental conditions are given. Conversely, the prediction unit 150 may derive the smart farm operating conditions for maximizing the crop production.

In addition, the prediction unit 150 may predict the crop production via the first prediction model when the current environmental conditions and the forecasted weather data are given. In addition, the prediction unit 150 may determine the optimal crop production direction (which refers to a production policy, operational strategy, or cultivation strategy) based on the predicted crop production, and derive the smart farm operating conditions corresponding to the determined optimal crop production direction.

For example, when the predicted crop production is greater than the average production (or set production), the smart farm operating conditions may be derived to reduce the crop production and smart farm operating costs, and when the predicted crop production is lower than the average production (or set production), the smart farm operating conditions may be derived to increase the crop production and smart farm operating costs.

The prediction unit 150 described above may determine the optimal crop production capable of maximizing profit based on the crop production predicted via the first prediction model and the historical crop price information, and may also derive the smart farm operating conditions corresponding to the determined optimal crop production.

In addition, the prediction unit 150 may predict the crop production via the first prediction model when the current environmental conditions and the forecasted weather data are given and predict future crop prices via the second prediction model based on the forecasted weather data. In addition, the prediction unit 150 may determine the optimal crop production direction capable of maximizing profit based on based on the predicted crop production and the future crop prices, and derive the smart farm operating conditions corresponding to the determined optimal crop production direction.

For example, based on the predicted crop production and the future crop prices, when the crop production is greater than the average production (or set production) and the predicted price is lower than the set price, the prediction unit 150 may derive the smart farm operating conditions to reduce the crop production and smart farm operating costs, and when the crop production is lower than the average production (or set production) and the predicted price is greater than the set price, derive the smart farm operating conditions to increase the crop production and smart farm operating costs, thereby maximizing profit.

Meanwhile, the predicted result providing unit 160 receives, as input, a prediction request from a user, requests a prediction from the prediction unit 150 according to the prediction request, and generates a response via a language model based on the predicted results of the prediction unit 150 and provides the generated response to the user.

The predicted result providing unit 160 may be linked with the language model to generate, in natural language, descriptions of the crop production predicted by the prediction unit 150 and the smart farm operating conditions derived to obtain the predicted crop production and provide the generated descriptions to the user in the form of text, voice, or the like.

Here, the natural language refers to a language used daily by humans and includes both the text and voice.

The predicted result providing unit 160 may provide the crop production predicted by the prediction unit 150 and the smart farm operating conditions derived to obtain the predicted crop production in the form of a graph, and may also provide accuracy and error values to confirm how much the prediction is accurate.

The information that may be provided to the user through the predicted result providing unit 160 may include, but is not limited to, the predicted crop production, recommended fertilizer, supply amount and cycle, recommended fertilizer mixing ratio, appropriateness of current environmental conditions (e.g., temperature, humidity, light intensity, etc.) and whether to change the environmental conditions, and crop growth rate compared to the same period in the past, etc.

The predicted result providing unit 160 described above may be linked with a retrieval-augmented generation system to generate and provide, in natural language, the descriptions of the crop production predicted by the prediction unit 150 and the smart farm operating conditions derived to obtain the predicted crop production, and may further retrieve relevant information (e.g., a reasonable basis for the determination of the smart farm operating conditions as set forth above) from the outside and then use the retrieved relevant information to generate the descriptions to be provided to the user.

In addition, the predicted result providing unit 160 may be linked with the retrieval-augmented generation system (RAG) to generate, in natural language, the descriptions of the crop production predicted by the prediction unit 150 and the smart farm operating conditions derived to obtain the predicted crop production and provide the generated descriptions to the user and generate and provide an answer (e.g., “Too low humidity may lead to active pest reproduction”) to a question (e.g., “Why should humidity be increased?”) from a user who has received the descriptions. In other words, if the user has any questions about the received smart farm operating conditions, the user may ask the questions in a chat format and receive the answers to the questions.

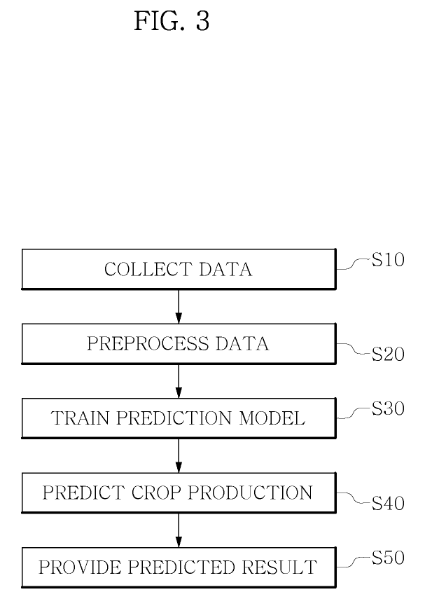

FIG. 3 is a flowchart for describing a method for operating a smart farm based on AI according to an embodiment of the present disclosure.

The method for operating a smart farm based on AI according to the present disclosure may be performed on a configuration substantially identical to an apparatus 100 for operating a smart farm based on an artificial intelligence illustrated in FIG. 1.

First, in step S10, the crop cultivation data may be collected during the operation of the smart farm.

The crop cultivation data collected in the above step S10 may include at least one of environmental data, soil and nutrient data, crop growth data, irrigation and resource usage data, smart farm operation data, and crop production data.

In addition, in the above step S10, the crop price data for the set period and the weather data for the corresponding period may be collected.

Here, the set period may be the same as the cultivation data collection period.

The crop cultivation data, the crop price data, the weather data, etc., collected in the above step S10 are the time-series data collected continuously over time.

The data storage unit 120 may store the data collected in the above step S10, i.e., the crop cultivation data, the crop price data, the weather data, etc., collected during the operation of the smart farm.

Thereafter, in step S20, time intervals of the data collected in the above step S10, i.e., the crop cultivation data, the crop price data, and the weather data collected during the operation of the smart farm may be adjusted to regular time intervals, the missing data may be predicted and supplemented, and the values of the collected data may be normalized to the fixed range.

Specifically, since the original (raw) data collected in the above step S10 may have issues such as sensor errors, missing values, and unit differences, in the above step S20, data sampling, data interpolation, data scaling, absolute value difference correction between data, etc., may be performed.

Performing the data preprocessing in the above step S20 may obtain better results in various machine learning algorithms.

In step S30, the first prediction model may learn (or be trained about) the correlation between the crop production and the smart farm operating conditions based on the crop cultivation data collected in the above step S10.

In the above step S30, the crop cultivation data collected in the above step S10 is preprocessed in the above step S20, and then the first prediction model may be trained using the preprocessed crop cultivation data.

The first prediction model described above may be implemented as the 1-1st prediction model and the 1-2nd prediction model. In the above step S30, the crop cultivation data collected in the above step S10 over the entire period may be as the training data to train the 1-1st prediction model, and the crop cultivation data of the recent predetermined period (e.g., the past year, the past two years, etc.) among the crop cultivation data collected in the above step S10 may be used as the training data to train the 1-2nd prediction model.

In addition, in the above step S30, the second prediction model may learn (or be trained about) the correlation between the crop prices and the weather based on the crop price data and weather data collected in the above step S10.

The second prediction model described above may be implemented as the 2-1st prediction model and the 2-2nd prediction model. In the above step S30, the 2-1st prediction model may be trained using, as the training data, the crop price data and weather data collected in the above step S10 over the entire period to train the 2-1st prediction model, and the 2-2nd prediction model may be trained using, as the training data, the crop price data and weather data of the recent predetermined period (e.g., the past year, the past two years, etc.) among the crop price data and weather data collected in the above step S10.

Thereafter, in step S40, the crop production may be predicted via the first prediction model according to the user's request, and the smart farm operating conditions for obtaining the predicted crop production may be derived.

In the above step S40, the smart farm operating conditions for obtaining maximum profit may be derived based on the predicted crop production.

In the above step S40, the crop production may be predicted on a time-series manner, for example, on a monthly or weekly basis, through time-series analysis.

In the above step S40, the crop production may be predicted using the crop cultivation data collected in the above step S10 over the entire period. That is, in the above S30, the crop production may be predicted via the 1-1st prediction model trained with the crop cultivation data collected in the above step S10 over the entire period.

In addition, in the above step S40, the crop production may be predicted using the crop cultivation data of the recent predetermined period (e.g., the past year, the past two years, etc.) among the crop cultivation data collected in the above step S10. That is, in the above step S30, the crop production may be predicted via the 1-2nd prediction model trained with the crop cultivation data of the recent predetermined period (e.g., the past year, the past two years, etc.) among the crop cultivation data collected in the above step S10.

In addition, in the above step S40, the median between the crop production predicted based on the entire period and the crop production predicted based on the recent period may be provided as the predicted results.

In addition, in the above step S40, the crop production may be predicted via the first prediction model when the current environmental conditions are given, the optimal crop production capable of maximizing profit may be determined by linking with the historical crop price information, and the derive smart farm operating conditions corresponding to the optimal crop production may be derived.

In the above step S40, the historical crop price information may be received as input separately or retrieved from the external database using the information retrieval function.

In addition, in the above step S40, the crop production may be predicted via the first prediction model when the current environmental conditions are given, and conversely, the smart farm operating conditions for maximizing the crop production may be derived.

In addition, in the above step S40, when the current environmental conditions and the forecasted weather data are given, the crop production may be predicted via the first prediction model, the optimal crop production direction may be determined based on the predicted crop production, and the smart farm operating conditions corresponding to the determined optimal crop production direction may be derived.

For example, when the predicted crop production is greater than the average production (or set production), the smart farm operating conditions may be derived to reduce the crop production and smart farm operating costs, and when the predicted crop production is lower than the average production (or set production), the smart farm operating conditions may be derived to increase the crop production and smart farm operating costs.

In the above step S40, the optimal crop production capable of maximizing profit based on the crop production predicted via the first prediction model and the historical crop price information may be determined, and the smart farm operating conditions corresponding to the determined optimal crop production may also be derived.

In addition, in the above step S40, the crop production may be predicted via the first prediction model when the current environmental conditions and the forecasted weather data are given and the future crop prices may be predicted via the second prediction model based on the forecasted weather data. In addition, the prediction unit 150 may determine the optimal crop production direction capable of maximizing profit based on based on the predicted crop production and the future crop prices, and derive the smart farm operating conditions corresponding to the determined optimal crop production direction.

For example, based on the predicted crop production and the future crop prices, when the crop production is greater than the average production (or set production) and the predicted price is lower than the set price, the prediction unit 150 may derive the smart farm operating conditions to reduce the crop production and smart farm operating costs, and when the crop production is lower than the average production (or set production) and the predicted price is greater than the set price, derive the smart farm operating conditions to increase the crop production and smart farm operating costs, thereby maximizing profit.

Thereafter, in step S50, the response may be generated and provided to the user via the language model based on the predicted results in the above step S40.

In the above step S50, the descriptions of the crop production predicted in the above step S40 and the smart farm operating conditions derived to obtain the predicted crop production may be generated in natural language and provided to the user in the form of text, voice, or the like.

In addition, in the above step S50, the crop production predicted in the above step S40 and the smart farm operating conditions derived to obtain the predicted crop production may be provided in the form of a graph, and may be provided together with the accuracy and error values to confirm how much the prediction is accurate.

In addition, in the above step S50, the information that may be provided to the user may include, but is not limited to, the predicted crop production, recommended fertilizer, supply amount and cycle, recommended fertilizer mixing ratio, appropriateness of current environmental conditions (e.g., temperature, humidity, light intensity, etc.) and whether to change the environmental conditions, and crop growth rate compared to the same period in the past, etc.

In addition, by being linked with the retrieval-augmented generation system (RAG) in the above step S50, when the descriptions of the crop production predicted in the above step S40 and the smart farm operating conditions derived to obtain the predicted crop production are generated and provided in natural language, the relevant information (e.g., a reasonable basis for the determination of the smart farm operating conditions as set forth above) may be retrieved from the outside and then used to generate the descriptions to be provided to the user.

In addition, by being linked with the retrieval-augmented generation system (RAG) in the above step S50, the descriptions of the crop production predicted in the above step S40 and the smart farm operating conditions derived to obtain the predicted crop production may be generated in natural language and provided to the user, and the answer (e.g., “Too low humidity may lead to active pest reproduction”) to the question (e.g., “Why should humidity be increased?”) from a user who has received the descriptions may be generated and provided.

As described above, according to the present disclosure, it is possible to predict the crop production and derive the smart farm operating conditions for maximizing the crop production.

In addition, it is possible to determine the optimal crop production capable of maximizing profit by linking the crop production with the crop prices and derive the smart farm operating conditions corresponding to the determined optimal crop production.

In addition, by providing the derived smart farm operating conditions to the user using the natural language, it is possible to intuitively describe the derived smart farm operating conditions to the user.

Also, the user may ask questions about the smart farm operating conditions in the chat format and receive the answers to the questions.

Hereinabove, although several preferred embodiments of the present disclosure have been described by way of example, it should be understood that the description of various embodiments set forth in the section entitled “Detailed Description of the Invention” is merely illustrative. It will be readily understood by those skilled in the art that the present disclosure can be variously modified and practiced, or equivalents thereof can be practiced, based on the foregoing description.

Furthermore, since the present disclosure may be embodied in various other forms, The present disclosure is not limited by the foregoing description, and the foregoing description is provided solely to complete the disclosure of the present disclosure and to fully inform a person of ordinary skill in the art to which the present disclosure pertains of the scope of the present disclosure. It should be noted that the present disclosure is defined solely by the respective claims of the appended claims.

What is claimed is:

1. An apparatus for operating a smart farm based on artificial intelligence, the apparatus comprising:
a data collection unit configured to collect crop cultivation data during the operation of the smart farm;
a training unit configured to train a first prediction model about a correlation between crop production and a smart farm operating condition based on the crop cultivation data collected by the data collection unit over a predetermined period;
a prediction unit configured to predict the crop production via the first prediction model and to derive the smart farm operating condition for obtaining maximum profit based on the predicted crop production; and
a predicted result providing unit configured to request a prediction from the prediction unit when a prediction request is input from a user, and to generate a response via a language model based on predicted results of the prediction unit and provides the response to the user.

2. The apparatus of claim 1, wherein the crop cultivation data includes at least one of environmental data, crop growth data, soil and nutrient data, irrigation and resource usage data, smart farm operation data, and crop production data,
the apparatus for operating the smart farm further comprising at least one of:
a data storage unit configured to store the data collected by the data collection unit; and
a data preprocessing unit configured to:
adjust a time interval of the data collected by the data collection unit to regular time intervals;
predict and supplements missing data; and
normalize values of the collected data to a fixed range.

3. The apparatus of claim 1, wherein the prediction unit predicts the crop production via the first prediction model, determines the crop production that maximizes profit by linking with historical crop price information, and derives the smart farm operating condition corresponding to the crop production.

4. The apparatus of claim 1, wherein the prediction unit derives the smart farm operating condition for maximizing the crop production via the first prediction model, and
inputs forecasted weather data to the first prediction model to predict the crop production, determines a crop production direction based on the predicted crop production, and derives the smart farm operating condition corresponding to the determined crop production direction.

5. The apparatus of claim 1, wherein the first prediction model is implemented as a 1-1st prediction model and a 1-2nd prediction model, and
the training unit uses, as training data, crop cultivation data collected by the data collection unit over an entire period to train the 1-1st prediction model, and uses, as training data, crop cultivation data of a recent predetermined period among the crop cultivation data collected by the data collection unit to train the 1-2nd prediction model.

6. The apparatus of claim 5, wherein the prediction unit predicts entire period-based crop production via the 1-1st prediction model and derives the smart farm operating condition for obtaining the predicted crop production, or
predicts crop production based on a recent period via the 1-2nd prediction model and derives the smart farm operating condition for obtaining the predicted crop production.

7. The apparatus of claim 1, wherein the predicted result providing unit is linked with the language model to generate and provide, in natural language, descriptions of the crop production predicted by the prediction unit and the smart farm operating condition derived to obtain the predicted crop production.

8. The apparatus of claim 1, wherein the predicted result providing unit is linked with a retrieval-augmented generation system to generate and provide, in natural language, descriptions of the crop production predicted by the prediction unit and the smart farm operating condition derived to obtain the predicted crop production, and retrieves relevant information from outside and then uses the retrieved relevant information to generate descriptions to be provided to the user.

9. The apparatus of claim 8, wherein the predicted result providing unit is linked with the retrieval-augmented generation system to generate and provide, in natural language, the descriptions of the crop production predicted by the prediction unit and the smart farm operating conditions derived to obtain the predicted crop production, and generates and provides an answer to a user's question.

10. The apparatus of claim 1, wherein the data collection unit collects crop price data for a set period and weather data for the corresponding period,
the training unit trains a second prediction model about a correlation between crop price and weather based on the price and weather data collected by the data collection unit, and
the prediction unit inputs forecasted weather data to the second prediction model to predict a future crop price, and determines a crop production direction based on the crop production predicted by the first prediction model and the future crop price predicted by the second prediction model, and then derives the smart farm operating condition corresponding to the determined crop production direction.

11. A method for operating a smart farm based on artificial intelligence, comprising:
collecting crop cultivation data during the operation of the smart farm;
training a first prediction model about a correlation between crop production and a smart farm operating condition based on the crop cultivation data collected in the collecting of the crop cultivation data over a predetermined period;
predicting the crop production via the first prediction model and deriving the smart farm operating condition for obtaining the predicted crop production; and
generating a response via a language model based on predicted results in the predicting of the crop production and providing the generated response to a user.

12. The method of claim 11, further comprising:
preprocessing data by adjusting a time interval of data collected in the collecting of the crop cultivation data to regular time intervals, predicting and supplementing missing data, and normalizing values of the collected data to a fixed range.

13. The method of claim 11, wherein, the predicting of the crop production comprises:
predicting the crop production via the first prediction model;
determining the crop production that maximizes profit by linking with historical crop price information; and
deriving the smart farm operating condition corresponding to the crop production, or deriving the smart farm operating condition for maximizing the crop production via the first prediction model.

14. The method of claim 11, wherein, the predicting of the crop production comprises:
inputting forecasted weather data to the first prediction model to predict the crop production;
determining a crop production direction based on the predicted crop production; and
deriving the smart farm operating condition corresponding to the determined crop production direction.

15. The method of claim 11, wherein the first prediction model is implemented as a 1-1st prediction model and a 1-2nd prediction model, and
wherein the training of the first prediction model comprises:
training the 1-1st prediction model by using crop cultivation data collected in the collecting of the crop cultivation data over an entire period as training data; and
training the 1-2nd prediction model by using crop cultivation data of a recent predetermined period among the crop cultivation data collected in the collecting of the crop cultivation data as the training data.

16. The method of claim 15, wherein, the predicting of the crop production comprises:
predicting entire period-based crop production via the 1-1st prediction model, and deriving the smart farm operating condition for obtaining the predicted crop production; or
predicting crop production based on a recent period via the 1-2nd prediction model, and deriving the smart farm operating condition for obtaining the predicted crop production.

17. The method of claim 11, wherein the providing of the predicted results comprises:
generating and providing, in natural language, descriptions of the crop production predicted in the predicting of the crop production and the smart farm operating condition derived to obtain the predicted crop production, by linking with the language model.

18. The method of claim 11, wherein the providing of the predicted results comprises:
generating and providing, in natural language, descriptions of the crop production predicted in the predicting of the crop production and the smart farm operating condition derived to obtain the predicted crop production, by linking with a retrieval-augmented generation system; and
generating descriptions to be provided to the user by retrieving relevant information from outside and then uses the retrieved relevant information.

19. The method of claim 18, wherein the providing of the predicted results comprises:
generating and providing, in natural language, the descriptions of the crop production predicted in the predicting of the crop production and the smart farm operating conditions derived to obtain the predicted crop production, by linking with the retrieval-augmented generation system; and
generating and providing an answer to a user's question.

20. The method of claim 11, wherein, in the collecting of the crop cultivation data comprises:
collecting crop price data for a set period and weather data for the corresponding period,
wherein the training of the first prediction model comprises:
training a second prediction model about a correlation between crop price and weather based on the price and weather data collected in the collecting of the crop cultivation data, and
wherein the predicting of the crop production comprises:
inputting forecasted weather data to the second prediction model to predict a future crop price; and
determining a crop production direction based on the crop production predicted by the first prediction model and the future crop price predicted by the second prediction model, and then deriving the smart farm operating condition corresponding to the determined crop production direction.
